(19) United States
(12) Patent Application Publication
(10) Pub. No.: US 2025/0316696 A1
(43) Pub. Date: Oct. 9, 2025

(54) ELECTRODE ASSEMBLY AND SECONDARY BATTERY COMPRISING THE SAME

(71) Applicant: SAMSUNG SDI CO., LTD., Gyeonggi-do (KR)

(72) Inventor: Young Kwang YUN, Gyeonggi-do (KR)

(73) Assignee: SAMSUNG SDI CO., LTD., Gyeonggi-do (KR)

(21) Appl. No.: 18/781,235

(22) Filed: Jul. 23, 2024

(30) Foreign Application Priority Data
Apr. 9, 2024 (KR) 10-2024-0047917

(51) Int. Cl. H01M 4/62; H01M 10/0525; H01M 50/536

(52) U.S. Cl. CPC H01M 4/625; H01M 4/133; H01M 4/134; H01M 10/0525; H01M 50/536

(57) ABSTRACT

Example embodiments relate to electrode assemblies and secondary batteries capable of preventing or reducing lithium precipitation in a negative electrode. The example embodiments are to provide the secondary battery that may prevent or reduce lithium precipitation in the negative electrode by increasing the ratio of the conductive additive in the negative electrode active material layer adjacent to the lead tab. The electrode assembly includes a first electrode, a second electrode and a separator, the first electrode includes a first current collector and a first active material layer, the second electrode includes a second current collector and a second active material layer, the second current collector includes a second uncoated portion, the second uncoated portion includes a connection region to which a second lead tab is connected.

### CROSS-REFERENCE TO THE RELATED APPLICATION

The present application claims the benefit of priority to Korean Patent Application No. 10-2024-0047917, filed on Apr. 9 2024, in the Korean Intellectual Property Office, the entire disclosure of which being incorporated herein by reference.

### BACKGROUND

### 1. Field

Example embodiments relate to an electrode assembly, and to a secondary battery including the electrode assembly.

### 2. Description of the Related Art

Unlike primary batteries that are typically not designed to be (re) charged, secondary (or rechargeable) batteries are typically designed to be discharged and recharged. Low-capacity secondary batteries are used in, e.g., portable, small electronic devices, such as smart phones, feature phones, notebook computers, digital cameras, and camcorders, and the like, while large-capacity secondary batteries are widely used as power sources for, e.g., driving motors in hybrid vehicles and electric vehicles, for storing power (e.g., home and/or utility scale power storage), and the like.

The electrode assembly includes a negative electrode plate, a positive electrode plate, and a separator between the electrode plates. The negative electrode plate and the positive electrode plate each include an uncoated portion where an active material layer is not disposed. An electrode tab is formed on the uncoated portion, and the current collector and the electrode plate may be electrically connected by the electrode tab.

When a secondary battery is charged and discharged, excess current may flow in a region of the negative electrode plate adjacent to the electrode tab compared to other regions. As a result, lithium may precipitate in the region of the negative electrode plate adjacent to the electrode tab.

### SUMMARY

Example embodiments include an electrode assembly and secondary battery with improved life and driving characteristics.

The electrode assembly according to an example embodiment includes a first electrode, a second electrode and a separator, the first electrode includes a first current collector and a first active material layer, the second electrode includes a second current collector and a second active material layer, the second current collector includes a second uncoated portion. In an example, the second uncoated portion includes a connection region to which a second lead tab is connected, the second active material layer includes a 2-1 active material layer and a 2-2 active material layer, the 2-1 active material layer is disposed between the connection region and the 2-2 active material layer, the 2-1 active material layer includes a first negative electrode active material, a 2-1 conductive additive, and a 2-1 binder, the 2-2 active material layer includes a second negative electrode active material, a 2-2 conductive additive, and a 2-2 binder, and a ratio of the 2-1 conductive additive is greater than the ratio of the 2-2 conductive additive. A ratio of the conductive additive is defined as the amount (weight %) of conductive additive contained in each active material layer.

In examples, a ratio of the 2-1 conductive additive is more than 1 to 2 times the ratio of the second conductive additive.

In other examples, the 2-1 conductive additive is included in an amount of about 1% to about 3% by weight based on 100% by weight of the 2-1 active material layer, the second conductive additive is included in an amount of more than 0% by weight to about 1% by weight based on 100% by weight of the 2-2 active material layer.

In an example, an area of the 2-1 active material layer is smaller than an area of the 2-2 active material layer.

In another example, the area of the 2-1 active material layer is about 5% to about 20% of the area of the 2-2 active material layer.

In an example, the second lead tab is formed integrally with the second uncoated portion.

In a further example, the electrode assembly is formed as a wound type or a stack type.

In an example, the 2-1 conductive additive and the 2-2 conductive additive comprises the same material

In other examples, a mixture density of the 2-1 active material layer is smaller than a mixture density of the 2-2 active material layer.

The electrode assembly according to an example embodiment includes a first electrode, a second electrode and a separator, the first electrode includes a first current collector and a first active material layer, the second electrode includes a second current collector and a second active material layer, the second current collector includes a second uncoated portion, the second uncoated portion includes a connection region to which a second lead tab is connected. In an example, the second active material layer includes a 2-1 active material layer and a 2-2 active material layer, the 2-1 active material layer is disposed between the connection region and the 2-2 active material layer, the 2-1 active material layer includes a first negative electrode active material, a 2-1 conductive additive, and a 2-1 binder, the 2-2 active material layer includes a second negative electrode active material, a 2-2 conductive additive, and a 2-2 binder, the 2-1 conductive additive and the 2-2 conductive additive include different materials.

In an example, the 2-1 conductive additive includes carbon nanotubes or graphene, and the 2-2 conductive additive includes carbon black.

In a further example, the 2-1 conductive additive includes carbon black, and the 2-2 conductive additive includes carbon nanotubes or graphene.

In other examples, an area of the 2-1 active material layer is smaller than an area of the 2-2 active material layer.

In further examples, the area of the 2-1 active material layer is about 5% to about 20% of the area of the 2-2 active material layer.

In an additional example, the electrode assembly is formed as a wound type or a stack type.

### BRIEF DESCRIPTION OF THE DRAWINGS

The accompanying drawings, which are incorporated in this specification, illustrate example embodiments and serve to further illustrate the technical ideas of the disclosure in conjunction with the detailed description of the example embodiments that follows, and the disclosure is not to be construed as limited to what is shown in such drawings. In the drawings:

FIG. 1 is a perspective view showing a secondary battery, according to an example embodiment.

FIG. 2 is a sectional view taken along line A-A′ of FIG. 1.

FIG. 3 is a top view showing a first electrode before winding the secondary battery according, to an example embodiment.

FIG. 4 is a top view showing a second electrode before winding the secondary battery, according to an example embodiment.

FIG. 5 is a sectional view taken along line B-B′ of FIG. 4.

FIG. 6 is a perspective view showing the secondary battery, according to an example embodiment.

FIG. 7 is a sectional view taken along line C-C′ of FIG. 6.

FIG. 8 is a top view showing the first electrode before winding the secondary battery, according to an example embodiment.

FIG. 9 is a top view showing the second electrode before winding the secondary battery, according to an example embodiment.

FIG. 10 is a sectional view taken along line D-D′ of FIG. 9.

FIG. 11 is a perspective view showing the secondary battery, according to an example embodiment.

FIG. 12 is a sectional view taken along line E-E′ of FIG. 11.

FIG. 13 is a top view showing the electrode assembly of the secondary battery, according to an example embodiment.

FIG. 14 is a partial sectional view taken along line F-F′ of FIG. 13.

FIG. 15 is a perspective view showing the secondary battery, according to an example embodiment.

FIG. 16 is a view explaining a method of coating a second active material layer of the secondary battery, according to example embodiments.

FIG. 17 is a perspective view showing a battery module including a secondary battery, according to an example embodiments.

FIGS. 18 and 19 are perspective views showing a battery pack including battery modules according to example embodiments.

FIGS. 20 and 21 are a perspective views showing a vehicle including battery packs according to example embodiments.

### DETAILED DESCRIPTION OF EXEMPLARY EMBODIMENTS

Hereinafter, example embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The example embodiments described in this specification and the configurations shown in the drawings are only some of the example embodiments of the present disclosure and do not represent all of the technical spirit, aspects, and features of the present disclosure. Accordingly, it should be understood that there may be various equivalents and modifications that can replace or modify the example embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing example embodiments of the present disclosure relates to “one or more example embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, when the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing example embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112 (a) and 35 U.S.C. § 132 (a).

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, otherwise unless stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or “A and B,” unless otherwise stated. That is, “and/or” includes any or all combinations of a plurality of items enumerated. When “C to D” is stated, it means C or more and D or less, unless otherwise specified.

Hereinafter, a secondary battery according to an example embodiment will be described with reference to the drawings.

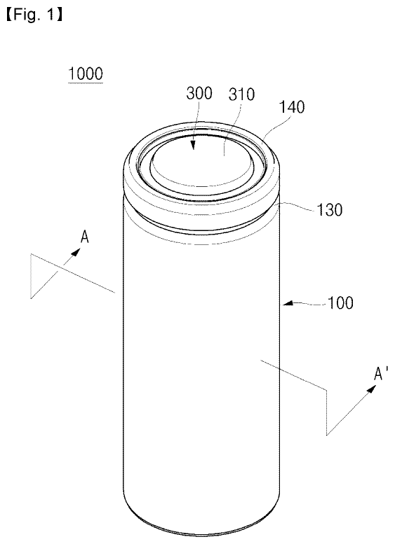

First, with reference to FIGS. 1 to 5, the secondary battery according to an example embodiment will be described.

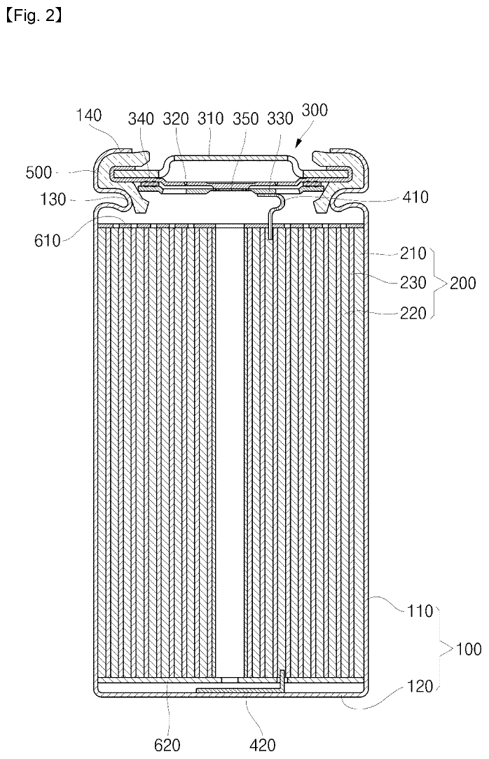

The secondary battery 1000 illustrated in FIGS. 1 and 2 includes an electrode assembly 200 (shown in FIG. 2), a case 100 containing the electrode assembly 200 and the electrolyte therein, and a cap assembly 300 coupled to the opening of the case 100 to seal the case 100, and an insulating plate 610 between the electrode assembly 200 and the cap assembly 300 inside the case 100.

As illustrated in FIG. 2, the electrode assembly 200 may include a separator 230, a first electrode 210 and a second electrode 220. The separator 230 is disposed between the first electrode 210 and the second electrode 220. The electrode assembly 200 may be wound in a jelly-roll shape.

As illustrated in FIG. 3, the first electrode 210 includes a first current collector 211 and a first active material layer 212 disposed on the first current collector 211. A first lead tab 410 may extend outward from a first uncoated portion of the first current collector 211 where the first active material layer 212 is not disposed, and the first lead tab 410 may be electrically connected to the cap assembly 300.

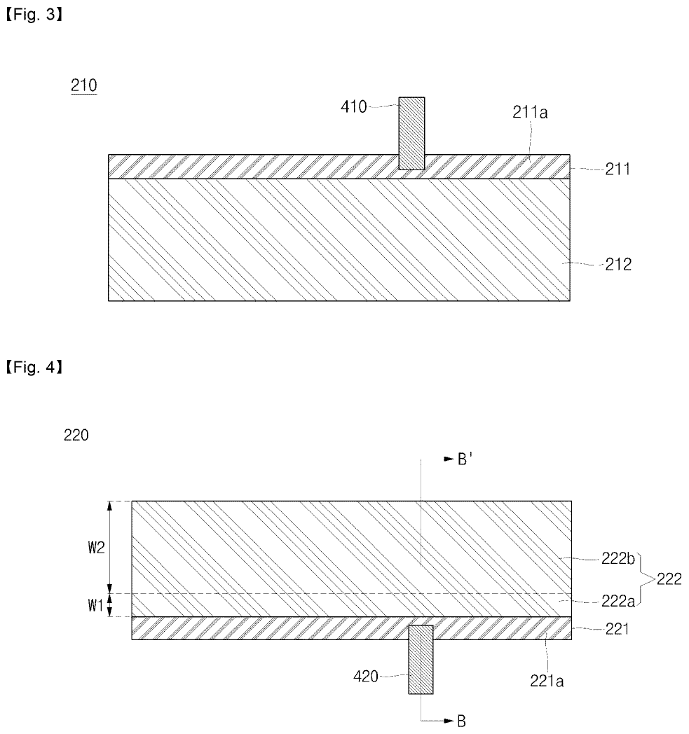

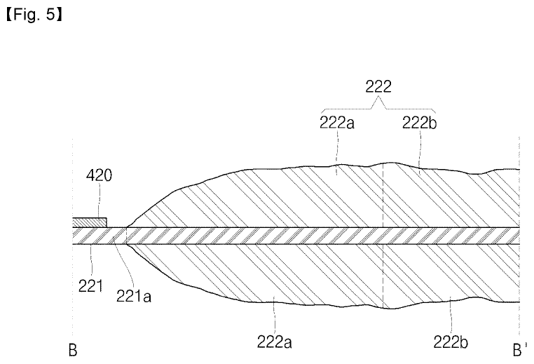

As illustrated in FIG. 4, the second electrode 220 includes a second current collector 221 and a second active material layer 222 disposed on the second current collector 221. A second lead tab 420 may extend outward from the second uncoated region 221a of the second current collector 221 where the second active material layer 222 is not disposed, and the second lead tab 420 may be electrically connected to the case 100 illustrated in FIG. 2. The first lead tab 410 and the second lead tab 420 may extend in opposite directions.

The first electrode 210 may be configured to be a positive electrode. In this case, the first current collector may be composed of or may include, for example, aluminum foil, and the first active material layer 212 may include, for example, a transition metal oxide. The second electrode 220 may be configured to be a negative electrode. In this case, the second current collector 221 may be composed of or may include, for example, copper foil or nickel foil, and the second active material layer 222 may include graphite, for example.

The separator 230 illustrated in FIG. 2 may be configured to reduce or prevent the occurrence of a short circuit between the first electrode 210 and the second electrode 220, while allowing movement of lithium ions therebetween. The separator 230 may be made of or include, for example, at least one of polyethylene film, polypropylene film, polyethylene-polypropylene film, and the like.

The case 100 accommodates the electrode assembly 200 and the electrolyte, and together with the cap assembly 300 forms the exterior of the secondary battery 1000. As illustrated in FIG. 2, the case 100 may include a substantially cylindrical body portion 110 and a bottom portion 120 connected to one side of the body portion. A beading portion 130 deformed toward the inside may be disposed in the body portion 110, and a crimping portion 140 bent toward the inside may be disposed at an end of the opening side of the body portion 110.

The beading portion 130 may be configured to reduce or prevent the electrode assembly 200 from moving inside the case 100, and facilitate seating of a gasket 500 and of the cap assembly 300. The crimping part 140 may firmly fix the cap assembly 300 by pressing the edge of the cap assembly 300 through the gasket 500. The case 100 may include iron plated with nickel.

The cap assembly 300 may be fixed to the inside of the crimping portion by the gasket 500. Thereby, the cap assembly 300 may seal the case 100. The cap assembly may include a cap up 310, a safety vent 320, a cap down 330, an insulating member 340, and a sub plate 350, but is not limited to this example and may be modified in various ways.

The cap up 310 may be disposed at the top of the cap assembly 300. The cap up 310 may protrude convexly upward and may include a terminal portion for connection to an external circuit. Also, the cap up 310 may include an outlet for discharging gas around the terminal portion.

The safety vent 320 may be disposed below the cap up 310. The safety vent may include protrusions and notches. The protrusion may protrude convexly downward and be connected to the sub plate 350. At least one notch may be disposed around the protrusion.

When gas is generated inside the secondary battery 1000 due to overcharging or malfunction of the secondary battery 1000, the protrusion may be deformed upward by pressure and separated from the sub plate 350. Accordingly, the safety vent may be cut along the notch. The gas may be discharged to the outside by a cut safety vent. Accordingly, explosion of the secondary battery may be reduced or prevented.

The cap down 330 may be disposed below the safety vent 320. The cap down may include a first opening and a second opening. The protrusion of the safety vent may be exposed by the first opening. The gas may be discharged through the second opening. The insulating member 340 may be disposed between the safety vent 320 and the cap down 330 to insulate the safety vent 320 and the cap down 330.

The sub plate 350 may be disposed below the cap down 330. The sub plate may be fixed to the lower surface of the cap down to block, or substantially block, the first opening. The protrusion of the safety vent may be fixed to the subplate. The first lead tab may be fixed to the sub plate 350. Accordingly, the cap up 310, the safety vent 320, the cap down 330, and the sub plate 350 may be electrically connected to the first electrode 210.

A first insulating plate 610 may be disposed below the beading portion 130. The first insulating plate 610 may be disposed in contact with the electrode assembly 200. The first insulating plate 610 may include a tab opening. The first lead tab 410 may be withdrawn through the tab opening. The first insulating plate 610 may be disposed between the cap assembly 300 and the electrode assembly 200. The cap assembly 300 is electrically connected to the first electrode 210 by the first lead tab 410. Also, the cap assembly 300 may be insulated from the electrode assembly 200 (second electrode) by the first insulating plate 610.

The second insulating plate 620 may be disposed on the bottom 120 of the secondary battery 1000. The second insulating plate 620 may be disposed in contact with the electrode assembly 200. The second insulating plate 520 may include a tab opening. The second lead tab 420 may be withdrawn through the tab opening. The second insulating plate 620 may be disposed between the bottom portion 120 and the electrode assembly 200. The case 100 is electrically connected to the second electrode 220 by the second lead tab 420. Also, the case 100 may be insulated from the electrode assembly (first electrode) 210 by the second insulating plate 620.

Referring to FIGS. 3 to 5, the first electrode 210 may include the first current collector 211 and the first active material layer 212. The first current collector 211 may include a first uncoated portion 211a. The first uncoated portion 211a may be a region where the first active material layer 212 is not disposed.

The first lead tab 410 may be electrically connected to one region of the first uncoated portion 211a. The first lead tab 410 may extend toward the top of the electrode assembly 200. In detail, the first lead tab 410 may extend in the direction of the cap assembly 300.

The first active material layer 212 may include at least one of a positive electrode active material, a first binder, and a first conductive additive.

The positive electrode active material may include a compound (lithiated intercalation compound) that is capable of intercalating and deintercalating lithium. For example, at least one of a composite oxide of lithium and a metal that includes at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b>0.5, 0≤c≤0.5, and 0≤α≤2); LiaNi1-b-cMnbXcO2-αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1-bGbO2 (0.90≤a≤1.8 and 0.001≤b≤0.1); LiaMn2GbO4 (0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4 (0.90≤a≤1.8).

In the above Chemical Formulas, A is or includes Ni, Co, Mn, or a combination thereof; X is or includes Al, Ni, Co, Mn, Cr, Fe, Mg, Sr, V, a rare earth element or a combination thereof; D is or includes 0, F, S, P, or a combination thereof; G is or includes Al, Cr, Mn, Fe, Mg, La, Ce, Sr, V, or a combination thereof; and L1 is or includes Mn, Al, or a combination thereof.

The positive electrode active material may be or include, for example, a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

An amount of the positive electrode active material may be about 90 wt % to about 99.5 wt % based on 100 wt % of the first active material 212. Amounts of the binder and the conductive additive may be about 0.5 wt % to about 5 wt %, respectively, based on 100 wt % of the first active material 212.

The first binder is configured to sufficiently attach the positive electrode active material particles to each other and also to sufficiently attach the positive electrode active material to the first current collector. Examples of the first binder may include, e.g., at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The first conductive additive may be used to impart conductivity (e.g., electrical conductivity) to the electrode. A material that does not cause chemical change (e.g., does not cause an undesirable chemical change in the rechargeable lithium battery) and conducts electrons can be used in the battery. Examples of the first conductive additive may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, etc., in a form of a metal powder or a metal fiber; a conductive polymer such as, or including, a polyphenylene derivative; or a mixture thereof.

The second electrode 220 may include the second current collector 221 and the second active material layer 222. The second current collector 221 may include a second uncoated portion 221a. The second uncoated portion 221a is a region where the second active material layer 222 is not disposed.

The second uncoated portion 221a may include a connection region on a portion thereof.

The second lead tab 420 may be electrically connected to one region of the second uncoated portion 221a. In detail, the second lead tab 420 may be connected to the connection region of the second uncoated portion 221a. That is, the region where the second lead tab 420 is connected may be the connection region of the second uncoated portion 221a. The second lead tab 420 may extend toward the bottom of the electrode assembly 200. In detail, the second lead tab 420 may extend toward the bottom portion of the case 100.

The second active material layer 222 may be divided into a 2-1 active material layer 222a and a 2-2 active material layer 222b depending on a location thereof. The 2-1 active material layer 222a may be adjacent to the second uncoated portion 221a. The 2-1 active material layer 222a may be adjacent to the connection region of the second uncoated portion 221a. The 2-1 active material layer 222a and the second uncoated portion 221a may form a boundary.

The 2-2 active material layer 222b may be spaced apart from the second uncoated portion 221a. Accordingly, the 2-1 active material layer 222a may be disposed between the connection region of the second uncoated portion 221a and the 2-2 active material layer 222b.

The 2-1 active material layer 222a may be disposed in part or over the entire region between the second uncoated portion 221a and the 2-2 active material layer 222b. The 2-1 active material layer 222a may overlap the connection region in the width or length direction of the second current collector 221.

The 2-1 active material layer 222a may have a first width W1. The 2-2 active material layer 222b may have a second width W2. The first width W1 and the second width W2 are defined as the width before winding the second electrode. The first width W1 is the maximum width of the 2-1 active material layer 222a, and the second width W2 is the maximum width of the 2-2 active material layer 222b.

The first width W1 and the second width W2 may be different. In detail, the first width W1 may be smaller than the second width W2. The lengths of the 2-1 active material layer 222a and the 2-2 active material layer 222b may be the same or similar. Accordingly, the area of the 2-1 active material layer 222a may be smaller than the area of the 2-2 active material layer 222b.

For example, the first width W1 may be about 5% to about 20%, about 7% to about 18%, or about 10% to about 15% of the second width W2.

For example, the area of the 2-1 active material layer 222a may be about 5% to about 20%, about 7% to about 18%, or about 10% to about 15% of the area of the 2-2 active material layer 222b.

When the area of the 2-1 active material layer 222a is less than about 5% of the area of the 2-2 active material layer 222b, a region where lithium precipitation occurs may be formed in the second active material layer 222. When the area of the 2-1 active material layer 222a exceeds about 20% of the area of the 2-2 active material layer 222b, the overall energy density of the second active material layer 222 may decrease.

The mixture density of the 2-1 active material layer 222a and the 2-2 active material layer 222b may be different. The difference in the mixture density between the 2-1 active material layer 222a and the 2-2 active material layer 222b may be caused by the ratio of the conductive additive. In detail, the mixture density of the 2-1 active material layer 222a may be smaller than the mixture density of the 2-2 active material layer 222b. The mixture refers to a slurry in which the active material, the conductive additive, and the binder are mixed. The mixture density (g/cc) refers to the degree to which the mixture material is pressed.

After coating the 2-1 active material layer 222a and the 2-2 active material layer 222b, a rolling process may be performed. The rolling process is carried out by the same roller. That is, the rolling process of the 2-1 active material layer 222a and the 2-2 active material layer 222b is performed simultaneously using the same roller. Therefore, even when the mixture density of the 2-1 active material layer 222a and the 2-2 active material layer 222b is different, the thickness of the 2-1 active material layer 222a and the thickness of the 2-2 active material layer 222b may be the same or similar after rolling.

The second active material layer 222 may include at least one of a negative electrode active material, a second binder, and a second conductive additive.

The negative electrode active material may include a material that reversibly intercalates/deintercalates at least one of lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. Crystalline carbon, amorphous carbon or a combination thereof. The crystalline carbon may be or include graphite such as non-shaped, sheet-shaped, flake-shaped, sphere-shaped, or fiber-shaped natural graphite or artificial graphite. The amorphous carbon may be or include a soft carbon, a hard carbon, a mesophase pitch carbonization product, calcined coke, and the like.

The lithium metal alloy includes an alloy of lithium and a metal that includes at least one of from Na, K, Rb, Cs, Fr, Be, Mg, Ca, Sr, Si, Sb, Pb, In, Zn, Ba, Ra, Ge, Al, and Sn.

The material capable of doping/dedoping lithium may be or include, e.g., a Si-based negative electrode active material or a Sn-based negative electrode active material. The Si-based negative electrode active material may include at least one of silicon, a silicon-carbon composite, SiOx (0<x<2), a Si-Q alloy (where Q includes at least one of from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO2, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The second binder may be configured to attach the negative electrode active material particles to each other, and also to attach the negative electrode active material to the current collector. The binder may include at least a non-aqueous binder, an aqueous binder, a dry binder, or a combination thereof.

The non-aqueous binder may include at least polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may include at least one of from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be or include a polymer material that is capable of being fibrous. For example, the dry binder may be or include polytetrafluoroethylene, polyvinylidene fluoride, a polyvinylidene fluoride-hexafluoropropylene copolymer, polyethylene oxide, or a combination thereof.

The conductive additive may be used to impart conductivity (e.g., electrical conductivity) to the electrode. Any material that does not cause chemical change (e.g., does not cause an undesirable chemical change in the rechargeable lithium battery) and that conducts electrons may be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative electrode active material, the second binder, and the second conductive additive may be included in weight percent within a set or desired range.

The 2-1 active material layer 222a and the 2-2 active material layer 222b may include active material layers having the same or a similar composition. Also, the 2-1 active material layer 222a and the 2-2 active material layer 222b may include active material layers having different composition ratios.

For example, the 2-1 active material layer 222a may include a first negative electrode active material, a 2-1 binder, and a 2-1 conductive additive. Also, the 2-2 active material layer 222b may include a second negative electrode active material, a 2-2 binder, and a 2-2 conductive additive.

The first negative electrode active material and the second negative electrode active material may include the same or similar materials. In an example, the 2-1 binder and the 2-2 binder may include the same or similar materials. In another example, the 2-1 conductive additive and the 2-2 conductive additive may include the same or similar materials.

The ratio of the 2-1 conductive additive and the ratio of the 2-2 conductive additive may be different. In an example, the ratio of the first negative electrode active material and the ratio of the second negative electrode active material may be different.

In detail, the ratio of the 2-1 conductive additive may be greater than the ratio of the 2-2 conductive additive. For example, the ratio of the 2-1 conductive additive may be more than 1 to 2 times, 1.2 to 1.8 times, or 1.4 to 1.6 times the ratio of the 2-2 conductive additive.

For example, the 2-1 conductive additive may be included in an amount of about 1% to about 3% by weight based on 100% by weight of the 2-1 active material layer 222a. Also, the second conductive additive may be included in an amount of more than 0% by weight to about 18 by weight based on 100% by weight of the 2-2 active material layer 222b.

Depending on the difference between the 2-1 conductive additive and the 2-2 conductive additive, the ratio of the first negative electrode active material and the second negative electrode active material may vary. That is, the ratio of the first negative electrode active material may be smaller than the ratio of the second negative electrode active material. That is, the 2-1 active material layer has a relatively large proportion of the 2-1 conductive additive and a relatively small proportion of the first negative electrode active material. Also, the 2-2 active material layer has a relatively small proportion of the 2-2 conductive additive and a relatively large proportion of the second negative electrode active material.

The 2-1 active material layer includes a large amount of conductive additive. Accordingly, the charging characteristics of the 2-1 active material layer may be improved. Lithium may be precipitated on the second electrode 220 by repeated charging and discharging of the secondary battery 100. In particular, the 2-1 active material layer adjacent to the second lead tab 420 may receive a substantial amount of load during charging. Therefore, the 2-1 active material layer has a relatively higher possibility of lithium precipitating than the 2-2 active material layer. When the lithium precipitates, the life of the secondary battery 100 may be reduced.

To reduce or prevent lithium precipitation, the ratio of the conductive additive in the 2-1 active material layer may be increased. Therefore, the 2-1 active material layer may reduce or prevent lithium from being precipitated from the negative electrode active material even when overloaded. In detail, during charging (particularly rapid charging), electrons are first consumed in the 2-1 active material layer where lithium is first inserted. The overall second active material layer may have an average potential, but locally, the charge may be concentrated in the 2-1 active material layer, which is charged first. When the conductive additive content of the 2-1 active material increases, the load ratio for each position of the 2-1 active material may decrease. Therefore, the local load (overcharge) of the 2-1 active material may be solved. Accordingly, the charging characteristics of the secondary battery may be improved.

Therefore, even when charging and discharging of the secondary battery is repeated and the charge is concentrated in the 2-1 active material layer adjacent to the second lead tab 420, lithium deposition from the 2-1 active material layer may be reduced or minimized.

Accordingly, the life and charging/discharging reliability of the secondary battery may be improved.

In an example, the 2-2 active material layer may have a relatively small proportion of the conductive additive.

That is, the 2-2 active material layer has a relatively large proportion of negative electrode active material. In an example, the area ratio of the 2-1 active material layer and the 2-2 active material layer is controlled within a set or desired range.

The mixture density of the 2-1 active material layer 222a and the 2-2 active material layer 222b may vary depending on the difference in the ratio of the conductive additive. The mixture density of the 2-1 active material layer 222a may be relatively small depending on the ratio of the 2-1 conductive additive. The mixture density of the 2-2 active material layer 222b may be relatively large depending on the ratio of the 2-2 conductive additive.

Since the mixture densities of the 2-1 active material layer 222a and of the 2-2 active material layer 222b are different, the energy density of the 2-1 active material layer 222a may be lower than the energy density of the 2-2 active material 222b.

By controlling the area ratio of the 2-1 active material layer and the 2-2 active material layer within a set or desired range, the overall specific capacity, energy density, and mixture density of the second active material layer may be hindered or prevented from decreasing.

Accordingly, the secondary battery according to an example embodiment may reduce or prevent lithium precipitation in the second active material layer by increasing the ratio of the conductive additive in the 2-1 active material layer adjacent to the connection region of the lead tab. Also, the secondary battery according to the first example embodiment includes a 2-2 active material layer having a relatively small conductive additive ratio. The areas of the 2-1 active material layer and the 2-2 active material layer are controlled within a set or desired range. Accordingly, the specific capacity, energy density, and mixture density of the second electrode may be hindered or prevented from decreasing. Accordingly, the secondary battery according to the first example embodiment may have improved life, reliability, and charge/discharge characteristics.

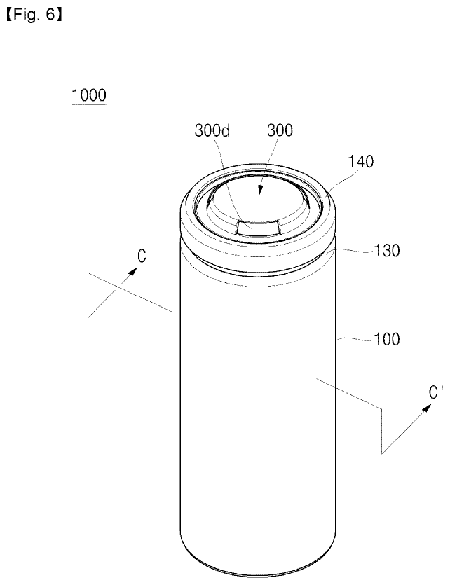

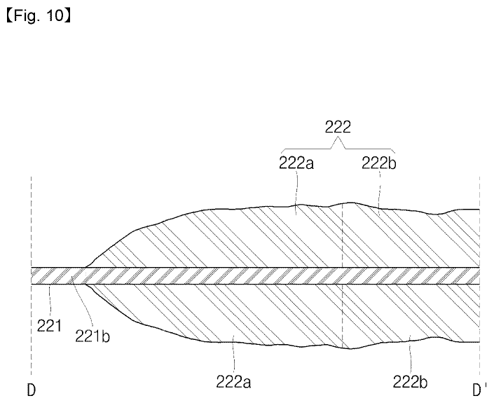

Hereinafter, the secondary battery according to another example embodiment will be described with reference to FIGS. 6 to 10. The same description as the first example embodiment described above will be omitted. The same components as in the above example embodiment are given the same reference numerals.

Unlike the first example embodiment described above, the secondary battery according to the second example embodiment described below does not include a separate lead tab connected to the uncoated portion.

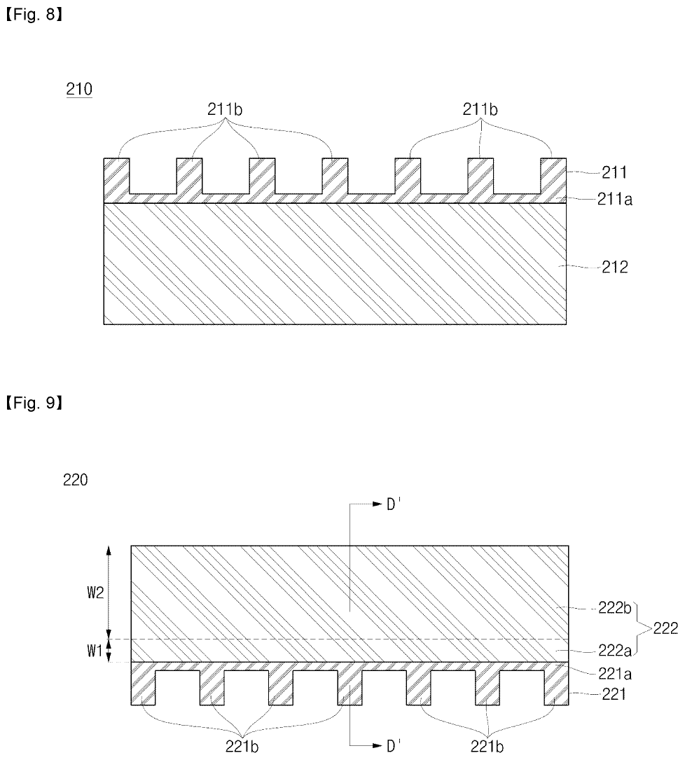

Referring to FIGS. 6 to 10, specifically as illustrated in FIG. 8, the first electrode 210 may include the first current collector 211 and the first active material layer 212. The first current collector 211 may include a first uncoated portion 211a and a plurality of first tabs 211b. The first tab 211b may be a lead tab. The first uncoated portion 211a is a region where the first active material layer 212 is not disposed. The first tab 211b may be one region of the first uncoated portion 211a. The first tab 211b is formed by the first uncoated portion 211a. For example, the first uncoated portion 211a and the first tab 211b may be formed integrally. The first tab 211b includes a plurality of tabs spaced apart from each other. The first tab 211b may extend toward the top of the electrode assembly. In detail, the first tab 211b may extend in the direction of the cap assembly 300.

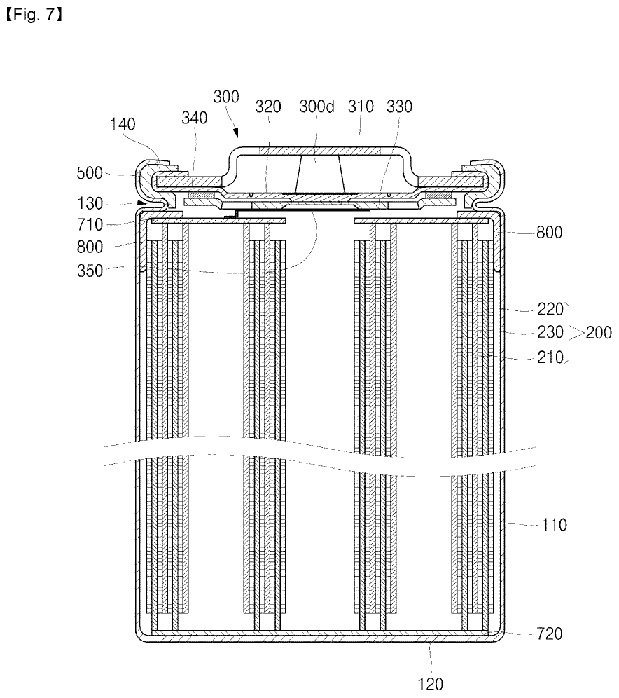

With respect to FIG. 7, a first current collector plate 710 may be disposed on the first tab 211b. The first current collector plate 710 may be disposed between the electrode assembly 200 and the cap assembly 300. The first current collector plate 710 may be disposed between the sub plate 350 and the electrode assembly 200.

The first electrode 210 may be in contact with the first current collector plate 710. For example, the first tab 211b may be connected to the first current collector plate 710. For example, the first tab 211b and the first current collector plate 710 may be connected by welding. Accordingly, the first electrode 210 and the first current collector plate 710 may be electrically connected. Accordingly, the first electrode 210 may be electrically connected to the cap up 310 by the first current collecting plate 710, the sub-plate 350, the cap down 330, and the safety vent 320. Accordingly, the cap up 310 may be a positive terminal.

The second electrode 220 may include the second current collector 221 and the second active material layer 222. The second current collector 221 may include a second uncoated portion 221a and a plurality of second tabs 221b. The second tab 211b may function as a lead tab. That is, the second uncoated portion 221a and the lead tab may be formed integrally. Therefore, a separate lead tab is not required. The second uncoated portion 221a is a region where the second active material layer 222 is not disposed. The second tab 221b may be one region of the second uncoated portion 221a. The second tab 221b is formed by the second uncoated portion 221a. For example, the second uncoated portion 221a and the second tab 221b may be formed integrally. The second tab 221b may include a plurality of tabs spaced apart from each other. The second tab 221b may extend toward the bottom of the electrode assembly. In an example, the second tab 221b may extend toward the bottom portion of the case.

A second current collector plate 720 may be disposed below the second tab 221b. The second current collector plate 720 may be disposed between the electrode assembly 200 and the bottom portion 120.

The second electrode 220 may be in contact with the second current collector plate 720. In detail, the second tab 221b may be connected to the second current collector plate 720. For example, the second tab 221b and the second current collector plate 720 may be connected by welding. In detail, the second tab 221b may be welded while the second current collector plate 720 is in contact with the bottom portion 120.

Accordingly, the second electrode 220 and the second current collector plate 720 may be electrically connected. Accordingly, the second electrode 220 may be electrically connected to the case 100 through the second current collector plate 720. Accordingly, the case 100 may be a negative terminal.

As also illustrated in FIG. 7, a second insulating member 800 may be disposed between the case 100 and the electrode assembly 200. The second insulating member 800 may be disposed between the case 100 and the electrode assembly 200. Also, the second insulating member 800 may be disposed between the first current collector plate 710 and the case 100. That is, the second insulating member 800 may be disposed between the first current collector plate 710 and the beading portion 130.

The case 100 and the electrode assembly 200 may be insulated by the second insulating member 800. Also, the first current collector plate 710 and the case 100 may be insulated by the second insulating member 800.

The first active material layer 212 may include at least one of a positive electrode active material, a first binder, and a first conductive additive. The second active material layer 222 may include at least one of a negative electrode active material, a second binder, and a second conductive additive. Since the positive electrode active material, the negative electrode active material, the binder, and the conductive additive are the same or similar to those of the first example embodiment, the following description is omitted.

The second active material layer 222 may be divided into a 2-1 active material layer 222a and a 2-2 active material layer 222b depending on its location. The 2-1 active material layer 222a may be adjacent to the second uncoated portion 221a and the second tab 221b. The 2-1 active material layer 222a and the second uncoated portion 221a may form a boundary.

The 2-2 active material layer 222b may be spaced apart from the second uncoated portion 221a and the second tab 221b. Accordingly, the 2-1 active material layer 222a may be disposed between the second uncoated portion 221a and the 2-2 active material layer 222b. Also, the 2-1 active material layer 222a may be disposed between the second uncoated portion 221a and the second tab 221b.

The 2-1 active material layer 222a may be disposed in a portion of the region between the second uncoated portion 221a and the 2-2 active material layer 222b. The 2-1 active material layer 222a may overlap the second tab 221b in the width direction of the second current collector 221.

As illustrated in FIG. 9, the 2-1 active material layer 222a may have a first width W1. The 2-2 active material layer 222b may have a second width W2. The first width W1 and the second width W2 are defined as the width before winding the second electrode. The first width W1 is the maximum width of the 2-1 active material layer 222a, and the second width W2 is the maximum width of the 2-2 active material layer 222b.

The first width W1 and the second width W2 may be different. In an example, the first width W1 may be smaller than the second width W2. The lengths of the 2-1 active material layer 222a and the 2-2 active material layer 222b may be the same or similar to each other. Accordingly, the area of the 2-1 active material layer 222a may be smaller than the area of the 2-2 active material layer 222b.

For example, the first width W1 may be about 5% to about 20%, about 7% to about 188, or about 10% to about 15% of the second width W2.

For example, the area of the 2-1 active material layer 222a may be about 5% to about 20%, about 7% to about 18%, or about 10% to about 15% of the area of the 2-2 active material layer 222b.

When the area of the 2-1 active material layer 222a is less than about 5% of the area of the 2-2 active material layer 222b, a region where lithium precipitation occurs may be formed in the second active material layer 222. When the area of the 2-1 active material layer 222a exceeds about 20% of the area of the 2-2 active material layer 222b, the overall energy density of the second active material layer 222 may decrease.

The mixture density of the 2-1 active material layer 222a and the 2-2 active material layer 222b may be different. The difference in the mixture density between the 2-1 active material layer 222a and the 2-2 active material layer 222b may be caused by the ratio of the conductive additive. In detail, the mixture density of the 2-1 active material layer 222a may be smaller than the mixture density of the 2-2 active material layer 222b.

After coating the 2-1 active material layer 222a and the 2-2 active material layer 222b, a rolling process may be performed. The rolling process is carried out by the same roller. That is, the rolling process of the 2-1 active material layer 222a and the 2-2 active material layer 222b is performed simultaneously or contemporaneously using the same roller. Therefore, even when the mixture density of the 2-1 active material layer 222a and the 2-2 active material layer 222b is different, the thickness of the 2-1 active material layer 222a and the 2-2 active material layer 222b11 may be the same or similar after rolling.

The negative electrode active material layer may include at least one of a negative electrode active material, a second binder, and a second conductive additive.

The 2-1 active material layer 222a and the second active material layer 222b may include active material layers having the same or a similar composition. Also, the 2-1 active material layer 222a and the 2-2 active material layer 222b may include active material layers having different composition ratios.

For example, the 2-1 active material layer 222a may include a first negative electrode active material, a 2-1 binder, and a 2-1 conductive additive. Also, the 2-2 active material layer 222b may include a second positive electrode active material, a 2-2 binder, and a 2-2 conductive additive.

The first negative electrode active material and the second negative electrode active material may include the same or similar materials. Also, the 2-1 binder and the 2-2 binder may include the same or similar materials. Also, the 2-1 conductive additive and the 2-2 conductive additive may include the same or similar materials.

The ratio of the 2-1 conductive additive and the ratio of the 2-2 conductive additive may be different. Also, the ratio of the first negative electrode active material and the ratio of the second negative electrode active material may be different.

Since the ratio of the 2-1 conductive additive and the 2-2 conductive additive is the same as or similar to an example embodiment described above, the description thereof is omitted.

Also, the conductive additive ratio of the 2-1 active material layer and the 2-2 active material layer may be the same or similar. Also, the sizes of the 2-1 conductive additive and the 2-2 conductive additive may be different. For example, the particle size of the 2-1 conductive additive may be smaller than the particle size of the 2-2 conductive additive.

Since the particle sizes of the 2-1 conductive additive and the 2-2 conductive additive are the same or similar to those of the first example embodiment described above, the description thereof is omitted.

Accordingly, the secondary battery according to an example embodiment may reduce or prevent lithium precipitation in the second active material layer by increasing the amount of conductive additive in the 2-1 active material layer adjacent to the tab. Also, the secondary battery according to the second example embodiment includes a 2-2 active material layer having a relatively small amount of conductive additive. The areas of the 2-1 active material layer and the 2-2 active material layer may be within a set or desired range. Accordingly, the specific capacity, energy density, and mixture density of the second electrode may be hindered or prevented from decreasing. Accordingly, the secondary battery according to the second example embodiment may have improved life, reliability, and charge/discharge characteristics.

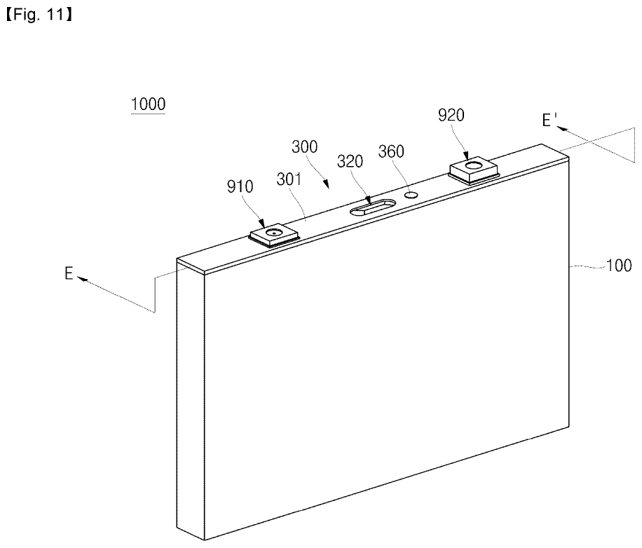

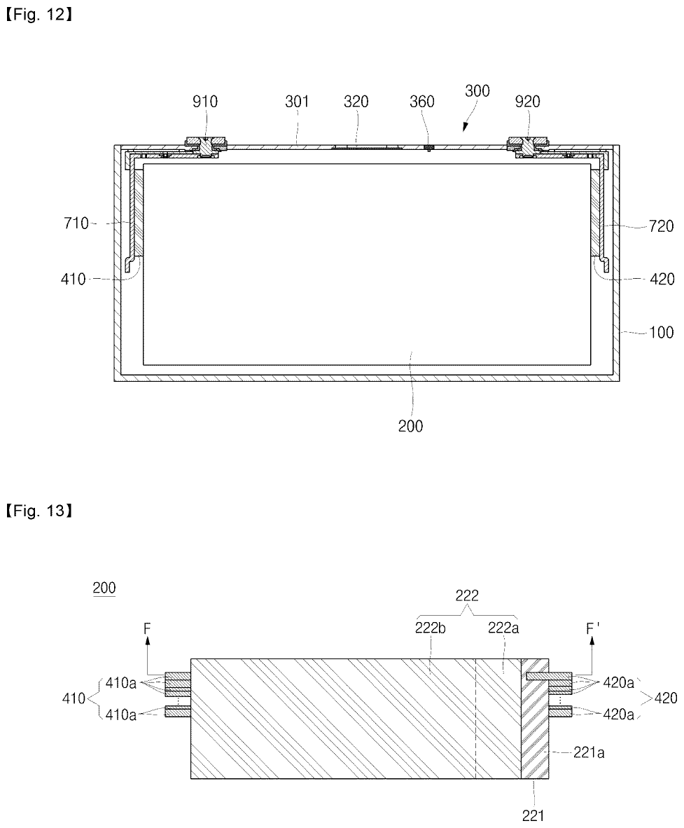

Hereinafter, the secondary battery according to another example embodiment will be described with reference to FIGS. 11 to 14. Descriptions identical to those of the previously described example embodiments will be omitted. Configurations that are the same as those in the above example embodiments are given the same reference numerals.

In the previous description, a circular secondary battery was described. The secondary battery according to the third example embodiment includes a prismatic secondary battery.

Referring to FIGS. 11 to 14, the secondary battery according to the third example embodiment may include the case 100, the cap assembly 300, and the electrode assembly 200. The electrode assembly 200 is accommodated inside the case 100. The case 100 is sealed by the cap assembly 300.

The cap assembly 300 is disposed on the upper portion of the case 100. The cap assembly 300 is coupled to the upper portion of the case 100. Accordingly, the case 100 may be sealed by the cap assembly 300.

The cap assembly 300 may include the cap plate 301 and a safety vent 320.

The cap plate 301 is coupled to the case 100. The cap plate 301 and the case 100 may be coupled by laser welding. The cap plate 301 may include the same material as the case 100.

The cap plate 301 includes a plurality of vent holes. The safety vent 320 is disposed in a region overlapping with the vent hole. The safety vent 320 may include a notch so that the safety vent 320 may be opened at a set or desired pressure.

The cap plate 301 may include an injection hole. The electrolyte may be injected by the injection hole. After the injection of electrolyte through the injection hole is completed, the injection hole may be sealed by a sealing cap 360. Therefore, it is possible to hinder or prevent the internal electrolyte from leaking.

The electrode assembly 200 may include the first electrode 210, the separator 230, and the second electrode 220. The electrode assembly 200 may be of a stack type. For example, the electrode assembly 200 may include an electrode module in which the first electrode 210, the separator 230, and the second electrode 220 are stacked. The electrode assembly may be formed by stacking a plurality of electrode modules.

The first electrode 210 may be electrically connected to the first terminal 910 by the first current collector plate 710. Also, the second electrode 220 may be electrically connected to the second terminal 920 by the second current collector plate 720. Accordingly, the first terminal 910 may be a positive terminal, and the second terminal 920 may be a negative terminal.

The first electrode 210 may include the first current collector 211 and the first active material layer 212. The first current collector 211 may include a first uncoated portion 211a. The first uncoated portion 211a is a region where the first active material layer 212 is not disposed.

The first lead tab 410 may be electrically connected to one region of the first uncoated portion 211a.

The first lead tab 410 may include a plurality of lead tabs 410a. In detail, the plurality of first current collectors 211 constituting the first electrode 210 may each include at least one first lead tab 410a.

The first active material layer 212 may include a positive electrode active material, a first binder, and a first conductive additive.

The second electrode 220 may include the second current collector 221 and the second active material layer 222. The second current collector 221 may include a second uncoated portion 221a. The second uncoated region 221a is a region where the second active material layer 222 is not disposed.

The second lead tab 420 may be electrically connected to one region of the second uncoated region 221a.

The second lead tab 420 may include a plurality of lead tabs 420a. In detail, the plurality of second current collectors 221 constituting the second electrode 220 may each include at least one second lead tab 420a.

The second active material layer 222 may include a negative electrode active material, a second binder, and a second conductive additive.

Since the positive electrode active material, the negative electrode active material, the binder, and the conductive additive are the same or similar to those of the first example embodiment, the description thereof is omitted.

The second active material layer 222 may be divided into a 2-1 active material layer 222a and a 2-2 active material layer 222b depending on a location thereof. The 2-1 active material layer 222a may be adjacent to the second uncoated portion 221a. The 2-1 active material layer 222a and the second uncoated region 221a may form a boundary.

The 2-2 active material layer 222b may be spaced apart from the second uncoated portion 221a. Accordingly, the 2-1 active material layer 222a may be disposed between the second uncoated portion 221a and the 2-2 active material layer 222b.

The 2-1 active material layer 222a may be disposed in a portion of the region between the second uncoated portion 221a and the 2-2 active material layer 222b. The 2-1 active material layer 222a may overlap the second lead tab 420 in the longitudinal or width direction of the second current collector 221.

The 2-1 active material layer 222a may have a first area. The 2-2 active material layer 222b may have a second area.

The first area and the second area may be different. For example, the first area may be smaller than the second area.

For example, the first area may be about 5% to about 20%, about 7% to about 18%, or about 10% to about 15% of the second area. When the first area is less than about 5% of the second area, a region where lithium precipitation occurs may be formed in the second active material layer 222. When the first area exceeds about 20% of the second area, the overall energy density of the second active material layer 222 may decrease.

The positive electrode active material, the second binder, and the second conductive additive may be included in weight percent within a set or desired range.

The 2-1 active material layer 222a and the second active material layer 222b may include active material layers having the same or a similar composition. Also, the 2-1 active material layer 222a and the 2-2 active material layer 222b may include active material layers having different composition ratios.

For example, the 2-1 active material layer 222a may include a first negative electrode active material, a 2-1 binder, and a 2-1 conductive additive. Also, the 2-2 active material layer 222b may include a second positive electrode active material, a 2-2 binder, and a 2-2 conductive additive.

The first negative electrode active material and the second negative electrode active material may include the same or similar materials. Also, the 2-1 binder and the 2-2 binder may include the same or similar materials. Also, the 2-1 conductive additive and the 2-2 conductive additive may include the same or similar materials.

The ratio of the 2-1 conductive additive and the ratio of the 2-2 conductive additive may be different. Also, the ratio of the first negative electrode active material and the ratio of the second negative electrode active material may be different.

Since the ratio of the 2-1 conductive additive and the 2-2 conductive additive is the same as or similar to the first example embodiment described above, the description thereof is omitted.

Accordingly, the secondary battery according to the third example embodiment may reduce or prevent lithium precipitation in the second active material layer by increasing the amount of conductive additive in the 2-1 active material layer adjacent to the tab. Also, in the secondary battery according to the third example embodiment, the areas of the 2-1 active material layer 222a and the 2-2 active material layer 222b are controlled within a set or desired range. Accordingly, the specific capacity, energy density, and mixture density of the second electrode may be hindered or prevented from decreasing. Accordingly, the secondary battery according to the third example embodiment may have improved life, reliability, and charge/discharge characteristics.

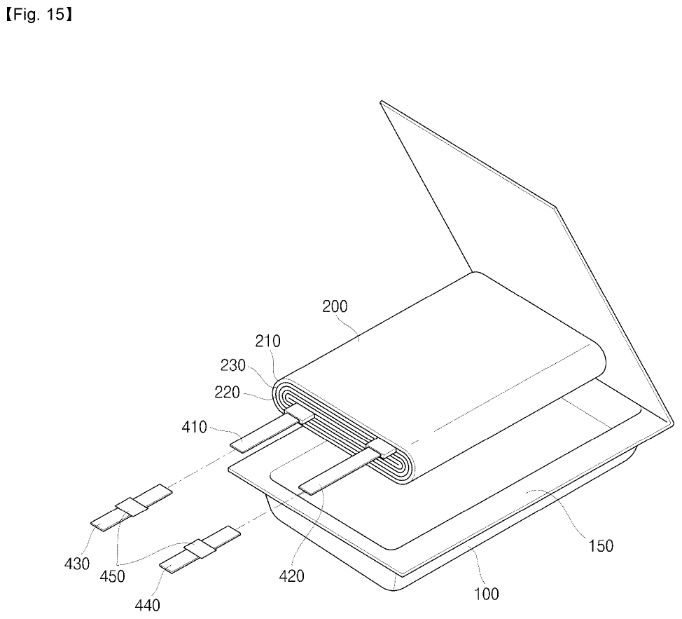

FIG. 15 is a perspective view showing the secondary battery according to a fourth example embodiment.

The secondary battery may be or include a pouch-type secondary battery.

Referring to FIG. 15, the secondary battery may include the case 100, the electrode assembly 200, the current collector, and a terminal.

The case 100 may include an accommodating portion where the electrode assembly 200 is placed. For example, the case may have a pouch shape.

The electrode assembly 200 may include the first electrode 210, the second electrode 220, and the separator 230. In the drawing, the first electrode 210, the second electrode 220, and the separator 230 are shown as being formed in a wound type, but the example embodiment is not limited thereto. The first electrode 210, the second electrode 220, and the separator 230 may be formed, e.g., in a stack type.

The first electrode 210 may include the first current collector and a first active material layer. The first current collector may include a first uncoated portion. The first uncoated portion is a region where the first active material layer is not disposed.

The first lead tab 410 may be electrically connected to one region of the first uncoated portion.

The first active material layer may include a positive electrode active material, a first binder, and a first conductive additive.

The second electrode 220 may include the second current collector and a second active material layer. The second current collector may include a second uncoated portion. The second uncoated portion is a region where the second active material layer is not disposed.

The second lead tab 420 may be electrically connected to one region of the second uncoated portion.

The second active material layer may include a negative electrode active material, a second binder, and a second conductive additive.

The first lead tab 410 and the second lead tab 420 may be welded to the positive electrode lead 430 and negative electrode lead 440 of the external terminals and are electrically connected to the outside. A tab film 450 may be attached to the positive electrode lead 430 and the negative electrode lead 440. The positive electrode lead 430 and the negative electrode lead 440 may be insulated from the case 100 by the tab film 450.

Since the positive electrode active material, the negative electrode active material, the binder, and the conductive additive are the same or similar to those of the first example embodiment, the description thereof is omitted.

The case 100 is sealed in contact with the sealing parts 150 at edges thereof while accommodating the electrode assembly 100. In this case, the tab film 450 is sealed in a state disposed between the sealing parts 150.

The second active material layer may be divided into a 2-1 active material layer and a 2-2 active material layer depending on a location thereof. The 2-1 active material layer may be adjacent to the second uncoated portion. The 2-1 active material layer and the second uncoated portion may form a boundary.

The 2-2 active material layer may be spaced apart from the second uncoated portion. Accordingly, the 2-1 active material layer may be disposed between the second uncoated portion and the 2-2 active material layer.

The 2-1 active material layer may be disposed in a portion of the region between the second uncoated portion and the 2-2 active material layer. The 2-1 active material layer may overlap the second lead tab in the longitudinal or width direction of the second current collector.

The 2-1 active material layer may have a first area. The 2-2 active material layer may have a second area.

The first area and the second area may be different from each other. In detail, the first area may be smaller than the second area.

For example, the first area may be about 5% to about 20%, about 7% to about 18%, or about 10% to about 15% of the second area. When the first area is less than 5% of the second area, a region where lithium precipitation occurs may be formed in the second active material layer 222. When the first area exceeds about 20% of the area of the second area, the overall energy density of the second active material layer 222 may decrease.

The anode active material, the second binder, and the second conductive additive may be included in weight percent within a set or desired range.

The 2-1 active material layer and the second active material layer 222 may include active material layers having the same or similar composition. Also, the 2-1 active material layer and the second active material layer 222 may include active material layers having different composition ratios.

For example, the 2-1 active material layer may include a first negative electrode active material, a 2-1 binder, and a 2-1 conductive additive. In another example, the second active material layer may include a second negative electrode active material, a second binder, and a second conductive additive.

The first negative electrode active material and the second negative electrode active material may include the same or similar materials. In another example, the −1 binder and the 2-2 binder may include the same or similar materials. In another example, the 2-1 conductive additive and the 2-2 conductive additive may include the same or similar materials.

The ratio of the 2-1 conductive additive and the ratio of the 2-2 conductive additive may be different. In an example, the ratio of the first negative electrode active material and the ratio of the second negative electrode active material may be different.

Since the ratio of the 2-1 conductive additive and the 2-2 conductive additive is the same as or similar to the first example embodiment described above, the description thereof is omitted.

Accordingly, the secondary battery according to the fourth example embodiment may reduce or prevent lithium precipitation in the second active material layer by increasing the amount of conductive additive in the 2-1 active material layer adjacent to the tab. Also, in the secondary battery according to the fourth example embodiment, the areas of the 2-1 active material layer and the 2-2 active material layer are controlled within a set or desired range. Accordingly, the specific capacity, energy density, and mixture density of the second electrode may be hindered or prevented from decreasing. Accordingly, the secondary battery according to the fourth example embodiment may have improved life, reliability, and charge/discharge characteristics.

In the description above, it was explained that the conductive additives of the 2-1 active material layer and the 2-2 active material layer are the same or similar. However, the example embodiment is not limited thereto.

The secondary battery according to the fifth example embodiment may include the same secondary battery as the first to fourth example embodiments described above. However, in the secondary battery according to the fifth example embodiment, the 2-1 active material layer and the 2-2 active material layer may include different types of conductive additives.

In detail, the 2-1 conductive additive and the 2-2 conductive additive may include conductive additives of different materials.

For example, the 2-1 conductive additive may include carbon nanotubes (CNT) or graphene. Also, the 2-2 conductive additive may include carbon black. The 2-1 conductive additive and the 2-2 conductive additive may be included in the same or similar ratio.

The carbon nanotubes or graphene have higher conductivity than the carbon black. Therefore, the 2-1 active material layer may reduce or prevent lithium from being precipitated from the negative electrode active material even when overloaded. In detail, during charging (particularly rapid charging), electrons are first consumed in the 2-1 active material layer where lithium is inserted first. The overall second active material layer may have an average potential, but locally, the charge may be concentrated in the 2-1 active material layer, which is charged first. When the 2-1 conductive additive includes a material having high conductivity, the load ratio for each position of the 2-1 active material may decrease. Therefore, the local load (overcharge)) of the 2-1 active material may be solved. Accordingly, the charging characteristics of the secondary battery may be improved.

Also, the energy density of the 2-1 active material layer is hindered or prevented from decreasing. Accordingly, the overall energy density of the second active material layer 222 may be hindered or prevented from decreasing.

Also, the 2-2 active material layer, which has a relatively small possibility of lithium precipitation, may include carbon black. Accordingly, the carbon black has a lower raw material cost than the carbon nanotube CNT or graphene. Accordingly, the process cost of manufacturing the second active material layer may be reduced.

Alternatively, the 2-1 conductive additive may include carbon black. Also, the 2-2 conductive additive may include carbon nanotubes or graphene. The 2-1 conductive additive and the 2-2 conductive additive may be included in different ratios.

The 2-1 conductive additive may be included in a larger proportion than the 2-2 conductive additive. Accordingly, the 2-1 active material layer may reduce or prevent lithium from being precipitated by the 2-1 conductive additive.

The carbon nanotubes or graphene have higher conductivity than the carbon black. Accordingly, the energy density of the 2-2 active material layer may increase. Therefore, the overall energy density of the second active material layer may increase.

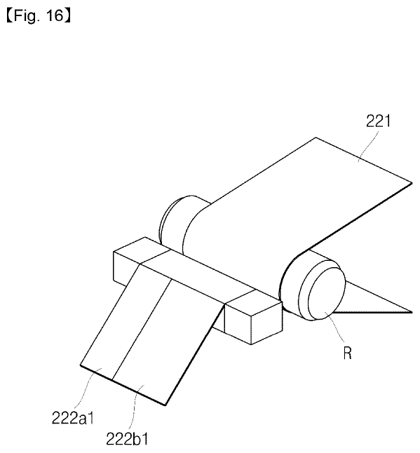

Hereinafter, a method of coating the second active material layer of the secondary battery according to example embodiments will be described with reference to FIG. 16.

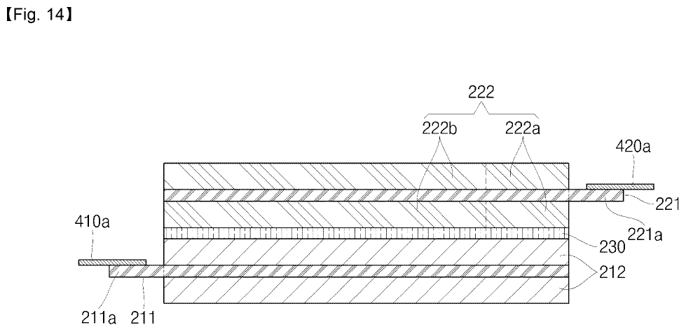

Referring to FIG. 16, the second current collector 221, unwound by a roller R, may be coated by two slurries. For example, the second current collector 221 may be coated by a first slurry 222al and a second slurry 222b1. The first slurry 222a1 may form the 2-1 active material layer 222a illustrated in, e.g., FOG. 14. The second slurry 222b1 may form the second active material layer 222b illustrated in, e.g., FIG. 14.

The first slurry 222al and the second slurry 222b1 may be simultaneously or contemporaneously coated on the second current collector 221.

According to the coating process, second active material layers with different amounts of conductive additive or sizes of the conductive additive may be readily formed on the second current collector 221.

As previously explained, the example coating process is followed by a rolling process. The rolling processes are carried out simultaneously by the same rollers. Therefore, even when the mixture density of the 2-1 active material layer 222a and the 2-2 active material layer 222b varies according to the ratio of the conductive additive, the thicknesses of the 2-1 active material layer 222a and the 2-2 active material layer 222b may be the same or similar.

Hereinafter, a battery module including the secondary battery according to example embodiments will be described with reference to FIG. 17.

Referring to FIG. 17, the battery module 2000 according to one or more example embodiments of the present disclosure includes a plurality of secondary battery 1000 arranged in one direction, a connection tab 20 connecting a secondary battery 1000a to an adjacent secondary battery 1000b, and a protection circuit module 30 having one end connected to the connection tab 20. The protection circuit module 30 may include a battery management system (BMS). Further, the connection tab 20 may include a body portion in contact with the electrode units 11 and 12 between the adjacent secondary battery 1000a and 1000b and an extension portion extending from the body portion and connected to the protection circuit module 30. The connection tab 20 may be, for example, a bus bar.

Each secondary battery 1000 may include a battery case, an electrode assembly received (or accommodated) in the battery case, and an electrolyte. The electrode assembly and the electrolyte react electrochemically to store and release (e.g., generate) energy. Terminal parts 11 and 12 electrically connected to the connection tab 20 and a vent 13 as a discharge passage for gas generated inside the battery case may be provided on one side of (e.g., an upper side of) the secondary battery 1000. The terminal parts 11 and 12 of the secondary battery 1000 may be a positive electrode terminal 11 and a negative electrode terminal 12 having different polarities from each other, and the terminal parts 11 and 12 of the adjacent secondary battery 1000a and 1000b may be electrically connected to each other in series or parallel by the connection tab 20, to be described in more detail below. Although a serial connection has been described as an example, the connection structure is not limited thereto, and various connection structures may be employed as desired or necessary. In addition, the number and arrangement of secondary battery is not limited to the structure shown in FIG. 14 and may be changed as desired or necessary.

The plurality of secondary batteries 1000 may be arranged in (e.g., may be stacked in) one direction so that the wide surfaces of the secondary batteries 1000 face each other, and the plurality of secondary batteries 1000 may be fixed by the housings 61, 62, 63, and 64. The housings 61, 62, 63, and 64 may include a pair of end plates 61 and 62 facing the wide surfaces of the secondary battery batteries 1000 and a side plate 63 and a bottom plate 64 connecting the pair of end plates 61 and 62 to each other. The side plate 63 may support side surfaces of the secondary batteries 1000, and the bottom plate 64 may support bottom surfaces of the secondary batteries 1000. In addition, the pair of end plates 61 and 62, the side plate 63 and the bottom plate 64 may be connected by bolts 65 and/or any other suitable fastening members and methods known to those of ordinary skill in the art.

The protection circuit module 30 may have electronic components and protection circuits mounted thereon and may be electrically connected to connection tabs 20, to be described in more detail later. The protection circuit module 30 includes a first protection circuit module 30a and a second protection circuit module 30b extending along the direction in which the plurality of secondary batteries 1000 are arranged in different locations. The first protection circuit module 30a and the second protection circuit module 30b may be spaced from each other at a suitable or desired interval (e.g., a predetermined interval) and arranged parallel to each other to be electrically connected to adjacent connection tabs 20, respectively. For example, the first protection circuit module 30a extends on one side of the upper portion of the plurality of secondary batteries 1000 along the direction in which the plurality of secondary batteries 1000 are arranged, and the second protection circuit module 30b extends to the other upper side of the plurality of secondary batteries 1000 along the direction in which the plurality of secondary batteries 1000 are arranged. The second protection circuit module 30b may be spaced from the first protection circuit module 30a at a suitable or desired interval (e.g., a predetermined interval) with the vents 34 interposed therebetween but may be disposed parallel to the first protection circuit module 30a. As such, the two protection circuit modules are spaced from each other side-by-side along the direction in which the plurality of secondary batteries 1000 are arranged, thereby reducing or minimizing the area of the printed circuit board (PCB) constituting the protection circuit module. By separately configuring the protection circuit module into two protection circuit modules, unnecessary PCM area can be reduced or minimized. In addition, the first protection circuit module 30a and the second protection circuit module 30b may be connected to each other by a conductive connection member 50. One side of the conductive connection member 50 is connected to the first protection circuit module 30a, and the other side thereof is connected to the second protection circuit module 30b so that the two protection circuit modules 30a and 30b can be electrically connected with each other.

The connection may be performed by any one of soldering, resistance welding, laser welding, projection welding and/or any other suitable connection methods known to those of ordinary skill in the art.

In addition, the connection member 50 may be or include, for example, an electric wire. In addition, the connection member 50 may be made of or include a material having elasticity or flexibility. By the connecting member 50, it may be possible to check and manage whether the voltage, temperature, and/or current of the plurality of secondary battery 1000 are normal or within a desired range. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 50.

In addition, when a secondary battery 1000 swells, shocks may be absorbed by the elasticity or flexibility of the connection member 50, thereby hindering or preventing the first and second protection circuit modules 30a and 30b from being damaged.

In addition, the shape and structure of the connection member 50 is not limited to the shape and structure shown in FIG. 17.

As described above, because the protection circuit module 30 is provided as the first and second protection circuit modules 30a and 30b, the area of the PCB constituting the protection circuit module can be reduced or minimized, and the space inside the battery module can be secured, which improves work efficiency by facilitating a fastening work for connecting the connection tab 20 and the protection circuit module 30 and repair work when an abnormality is detected in the battery module.

The secondary battery and battery modules according to the previously described example embodiments may be used to manufacture the battery pack.

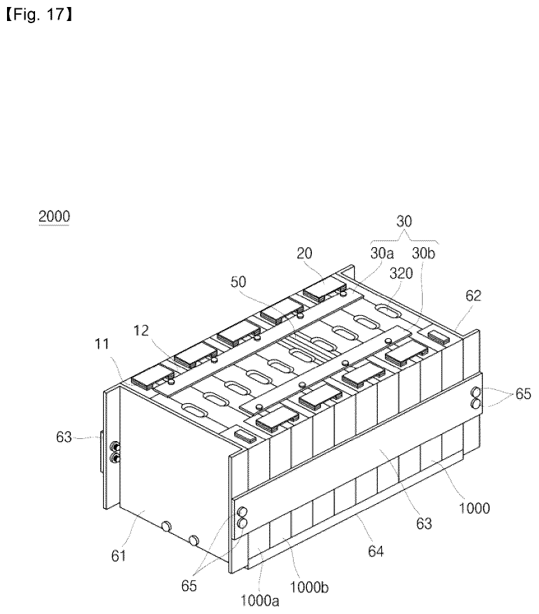

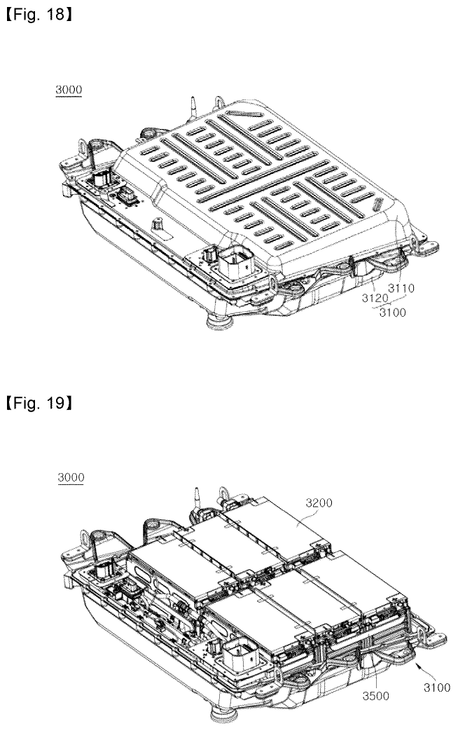

FIGS. 18 and 19 show a battery pack 3000 according to one or more example embodiments of the present disclosure. The battery pack 3000 may include a plurality of battery modules 3200 and a housing 3100 for accommodating the plurality of battery modules 3200. For example, the housing 3100 may include first and second housings 3110 and 3120 coupled in opposite directions through the plurality of battery modules 3200. The plurality of battery modules 3200 may be electrically connected to each other by using a bus bar, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In one or more example embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

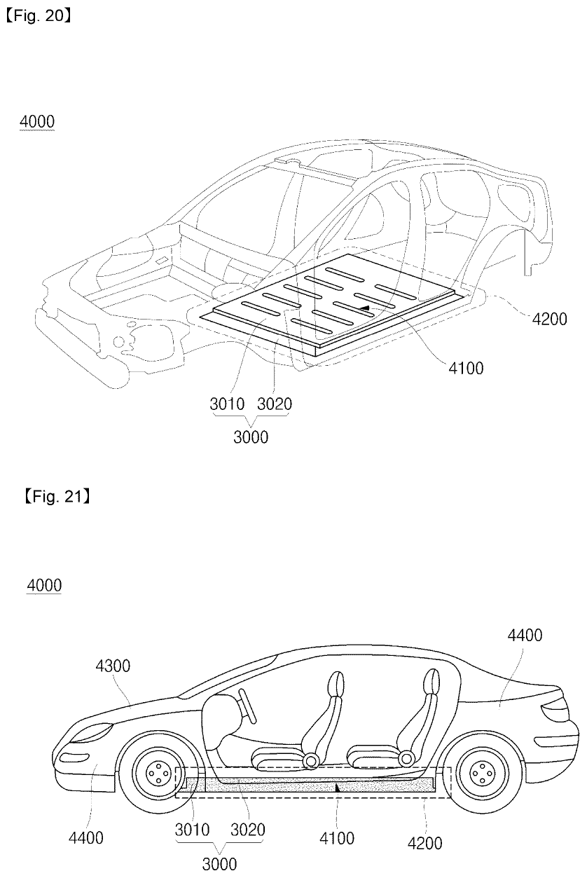

In FIG. 20, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle

In FIG. 21, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The electrode assembly and secondary battery according to example embodiments may reduce or prevent lithium precipitation in a second active material layer by increasing the ratio of a conductive additive in a 2-1 active material layer adjacent to the lead tab (or the tab formed by the uncoated portion). Also, the secondary batteries according to example embodiments include a 2-2 active material layer having a relatively small conductive additive ratio. The areas of the 2-1 active material layer and the 2-2 active material layer are controlled within a set or desired range. Accordingly, the specific capacity, energy density, and mixture density of the second electrode may be hindered or prevented from decreasing. Therefore, secondary batteries according to example embodiments may have improved life, reliability, and charge/discharge characteristics.

The electrode assembly and secondary battery according to embodiments may reduce or prevent lithium precipitation in the second active material layer by reducing the particle size of the conductive additive in the 2-1 active material layer adjacent to the lead tab (or the tab formed by the uncoated portion). Also, the secondary batteries according to example embodiments include the 2-2 active material layer having a relatively large conductive additive particle size. The areas of the 2-1 active material layer and the 2-2 active material layer are controlled within a set or desired range. Accordingly, the specific capacity, energy density, and mixture density of the second electrode may be hindered or prevented from decreasing. Therefore, secondary batteries according to example embodiments may have improved lifespan, reliability, and charge/discharge characteristics.

The above are only example embodiments for implementing a secondary battery according to the disclosure, the disclosure is not limited to the above example embodiments, and there is a technical spirit of the disclosure to the extent that various modifications can be made by anyone having ordinary skill in the art to which the disclosure pertains without departing from the gist of the disclosure as claimed in the following claims.

What is claimed is:

1. An electrode assembly comprising a first electrode, a second electrode and a separator,
wherein the first electrode comprises a first current collector and a first active material layer,
wherein the second electrode comprises a second current collector and a second active material layer,
wherein the second current collector comprises a second uncoated portion,
wherein the second uncoated portion comprises a connection region to which a second lead tab is connected, wherein the second active material layer comprises a 2-1 active material layer and a 2-2 active material layer,
wherein the 2-1 active material layer is between the connection region and the 2-2 active material layer,
wherein the 2-1 active material layer comprises a first negative electrode active material, a 2-1 conductive additive, and a 2-1 binder,
wherein the 2-2 active material layer comprises a second negative electrode active material, a 2-2 conductive additive, and a 2-2 binder,
wherein a ratio of the 2-1 conductive additive is greater than the ratio of the 2-2 conductive additive.

2. The electrode assembly as claimed in claim 1, wherein the ratio of the 2-1 conductive additive is more than 1 to 2 times the ratio of the 2-2 conductive additive.

3. The electrode assembly as claimed in claim 1, wherein the 2-1 conductive additive is comprised in an amount of about 1% to about 3% by weight based on 100% by weight of the 2-1 active material layer,
wherein the second conductive additive is comprised in an amount of more than 0% by weight to about 1% by weight based on 100% by weight of the 2-2 active material layer.

4. The electrode assembly as claimed in claim 1, wherein an area of the 2-1 active material layer is smaller than an area of the 2-2 active material layer.

5. The electrode assembly as claimed in claim 4, wherein the area of the 2-1 active material layer is about 5% to about 20% of the area of the 2-2 active material layer.

6. The electrode assembly as claimed in claim 1, wherein the second lead tab is formed integrally with the second uncoated portion.

7. The electrode assembly as claimed in claim 1, wherein the electrode assembly is formed as one of a wound type and a stack type.

8. The electrode assembly as claimed in claim 1, wherein the 2-1 conductive additive and the 2-2 conductive additive comprise a same material.

9. The electrode assembly as claimed in claim 1, wherein a mixture density of the 2-1 active material layer is smaller than a mixture density of the 2-2 active material layer.

10. An electrode assembly comprising a first electrode, a second electrode and a separator,
wherein the first electrode comprises a first current collector and a first active material layer,
wherein the second electrode comprises a second current collector and a second active material layer,
wherein the second current collector comprises a second uncoated portion,
wherein the second uncoated portion comprises a connection region to which a second lead tab is connected, wherein the second active material layer comprises a 2-1 active material layer and a 2-2 active material layer,
wherein the 2-1 active material layer is between the connection region and the 2-2 active material layer,
wherein the 2-1 active material layer comprises a first negative electrode active material, a 2-1 conductive additive, and a 2-1 binder,
wherein the 2-2 active material layer comprises a second negative electrode active material, a 2-2 conductive additive, and a 2-2 binder,
wherein the 2-1 conductive additive and the 2-2 conductive additive comprise different materials.

11. The electrode assembly as claimed in claim 10, wherein the 2-1 conductive additive comprises carbon nanotubes or graphene,
wherein the 2-2 conductive additive comprises carbon black.

12. The electrode assembly as claimed in claim 10, wherein the 2-1 conductive additive comprises carbon black,
wherein the 2-2 conductive additive comprises one of carbon nanotubes and graphene.

13. The electrode assembly as claimed in claim 10, wherein an area of the 2-1 active material layer is smaller than an area of the 2-2 active material layer.

14. The electrode assembly as claimed in claim 13, wherein the area of the 2-1 active material layer is about 5% to about 20% of the area of the 2-2 active material layer.

15. The electrode assembly as claimed in claim 10, wherein the electrode assembly is formed as one of a wound type and a stack type.

16. A secondary battery comprising;
a case;
an electrode assembly of claim 1 accommodated in the case;
a first lead tab electrically connected to the first electrode; and
a second lead tab electrically connected to the second electrode;
wherein the first current collector comprises a first uncoated portion,
wherein the first lead tab is connected to the first uncoated portion, and
wherein the second lead tab is connected to the connection area.

17. The secondary battery as claimed in claim 16, wherein the second lead tab is formed integrally with the second uncoated portion.

18. The secondary battery as claimed in claim 16, wherein the case comprises one of a circular shape, a prismatic shape, and a pouch shape.
